(19) United States
(12) Patent Application Publication
(10) Pub. No.: US 2012/0132734 A1
(43) Pub. Date: May 31, 2012

(54) SYSTEMS AND METHODS FOR PROCESSING ANIMAL WASTE

(75) Inventor: David DeWaard, Lynden, WA (US)

(73) Assignee: DARITECH, INC., Lynden, WA (US)

(21) Appl. No.: 13/299,720

(22) Filed: Nov. 18, 2011

Related U.S. Application Data
(60) Provisional application No. 61/417,387, filed on Nov. 26, 2010.

(51) Int. Cl. B02C 23/08

(52) U.S. Cl. 241/24.1; 241/68

(57) ABSTRACT

A flush system for processing waste slurry contains animal waste, comprising a primary separator, a primary digester, and a secondary digester. The primary separator separates the waste slurry into a first portion and a second portion. The primary digester digests the first portion. The secondary digester digests at least part of the second portion. A solids content of the first portion is higher than a solids content of the second portion.

### RELATED APPLICATIONS

This application (Attorney Docket No. P216840) claims benefit of priority to U.S. Provisional Application Ser. No. 61/417,387, filed Nov. 26, 2010.

The contents of the patent application(s) listed above are incorporated herein by reference.

### TECHNICAL FIELD

The present invention relates to manure processing systems and methods for use in dairy operations and, more specifically, to improved waste processing systems and methods for use with dairy facility flush systems.

### BACKGROUND

Dairy and similar livestock operations generate animal waste. The present invention is of particular significance in the field of dairy operations, and the invention will be described in the context of a dairy operation. The present invention may, however, have application to other environments.

In a dairy operation, cows are often held for periods of time in contained locations. Over time, cow waste collects in such contained locations and must be removed. Dairy systems thus typically use a flush system to remove cow waste from contained locations where the waste has collected. A flush system employs a pressurized liquid that is flushed onto the contained locations to remove the waste. The flush liquid and animal waste form a waste slurry that is collected and removed from the contained location.

The flush system thus requires both a continuous supply of flush liquid and a way to handle the waste slurry. To deal with both problems, processing systems have been developed that process the waste slurry generated by the flush system to obtain useable manure and to extract from the waste slurry a liquid suitable for use as the flush liquid.

Systems and methods of processing waste slurry generated by flush systems are described in U.S. Pat. No. 7,306,731 to DeWaard, and the contents of the DeWaard '731 patent are incorporated herein by reference. The waste processing system described in the DeWaard '731 patent employs an arrangement of settling and storage tanks and liquid/solid separators to obtain useable flush liquid and also to provide a supply of material suitable for use in a digester. The flush liquid may be re-used by a conventional flush system, while the digester process yields manure material that may be safely spread directly on soil as fertilizer and/or liquid that may be used as fertilizer.

A problem with the waste slurry processing system described in the '731 patent is that the amount of liquid volume that can economically be processed by the digester limits the size of the digester. To extract all of the latent energy from the waste, the digester must be significantly over sized. Typically, it is not cost effective to install a digester of sufficient size to process all of the waste slurry. Accordingly, in a typical implementation of the system described in the '731 patent, a portion of the waste slurry is not processed by the digester, and the energy latent in this unprocessed portion of the waste slurry is not recovered.

The present invention may be implemented as improved waste processing systems and methods for optimizing the processing of waste slurry arising from use of a dairy flush system.

### SUMMARY

The present invention may be embodied as a flush system for processing waste slurry contains animal waste, comprising a primary separator, a primary digester, and a secondary digester. The primary separator separates the waste slurry into a first portion and a second portion. The primary digester digests the first portion. The secondary digester digests the second portion. A solids content of the first portion is higher than a solids content of the second portion.

The present invention may also be embodied as a method of processing waste slurry containing animal waste comprising the following steps. The waste slurry is separated into a first portion and a second portion, and a solids content of the first portion is higher than a solids content of the second portion. The first portion is digested in a primary digester. The second portion is digested in a secondary digester.

The present invention may also be embodied as a flush system for processing waste slurry containing animal waste, comprising a first vessel, a second vessel, a low-rate digester, and a high-rate digester. The first vessel separates the waste slurry into a first thick fraction and a first thin fraction. The second vessel separates the second portion of the waste slurry into a second thick fraction and a second thin fraction. The low-rate digester digests the first thick fraction and at least a portion of the second thick fraction. The high-rate digester digests at least a portion of the first thin fraction.

### BRIEF DESCRIPTION OF THE DRAWINGS

FIG. 1 is a schematic view of a first example manure processing system of the present invention;

FIG. 2 is a schematic view of a second example manure processing system of the present invention;

FIG. 3 is a schematic view of a third example manure processing system of the present invention;

FIG. 4 is a schematic view of a fourth example manure processing system of the present invention; and

FIG. 5 is a schematic view of a fifth example manure processing system of the present invention.

### DETAILED DESCRIPTION

The principles of the present invention can be implemented in any number of different forms depending upon the nature of the particular operating environment, including available storage and disposal facilities and quantity and/or characteristics of the waste to be processed. Several example implementations of the present invention will be discussed separately below.

### I. First Example

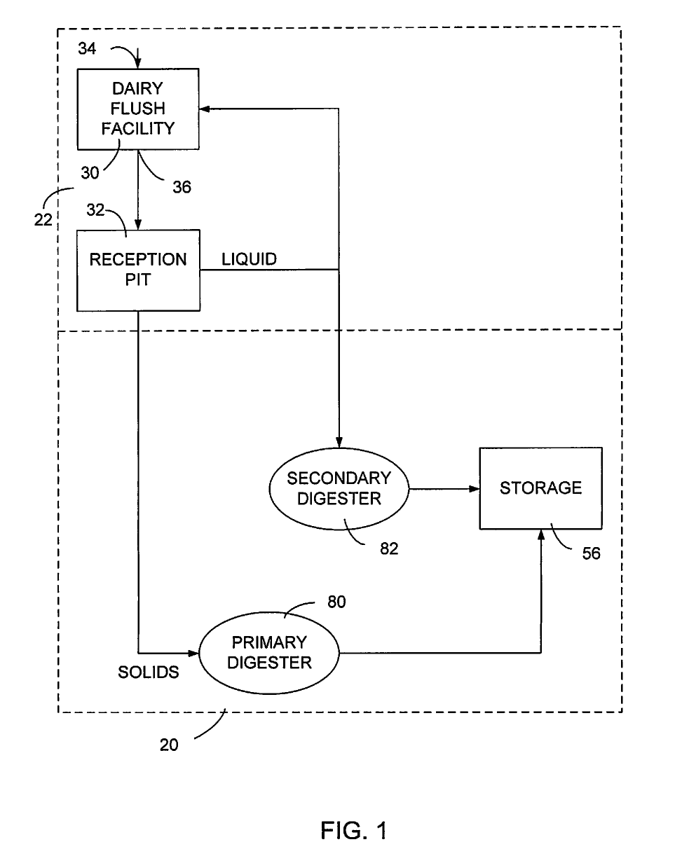

Referring initially to FIG. 1 of the drawing, depicted therein is a first example waste processing system 20 adapted to be used with a flush system 22. The example flush system 22 is or may be conventional and comprises a dairy flush facility 30 and a reception pit 32. The flush facility 30 comprises an inlet 34 through which flush fluid is introduced and an outlet 36 through which waste slurry is collected. During use of the flush system 22, the flush liquid is mixed with the animal waste to form waste slurry. The waste slurry flows through the outlet 36 and is collected in the reception pit 32.

The first example waste processing system 20 comprises a storage facility or structure 56, a primary digester 80, and a secondary digester 82. The primary digester 80 and the secondary digester 82 are configured to process digester mixtures having different characteristics.

The first example waste processing system 20 operates basically as follows. A solids portion, or first digester mixture or thick fraction, of the waste slurry collected by the reception pit 32 flows into the primary digester 80. A liquid portion, or second digester mixture or thin fraction, of the waste slurry collected by the reception pit 32 flows into the secondary digester 82.

In practice, when a given slurry material containing liquids and solids is separated into a thick fraction and a thin fraction, the thick fraction will comprise a high percentage of settleable solid material relative to the given material, while the thin fraction will comprise a relatively low percentage of settleable solid material relative to the given material. Both the thick fraction and the thin fraction contain biodegradable solid material, but the thick fraction will typically contain a higher percentage of biodegradable material than the thin fraction. Further, the ratio of unsettleable solid material to settleable solid material in the thin fraction will be typically be higher than the ratio of unsettleable solid material to settleable solid material in the thick fraction.

The primary digester 80 breaks the biodegradable material in the first digester mixture or thick fraction down into a first digested material. In the example first waste processing system 20, the first digested material is allowed to flow into the storage facility 56. In addition to processing a portion of the waste slurry, the primary digester 80 may further be configured to release useable energy from the solids portion processed thereby.

The secondary digester 82 breaks the biodegradable material in the second digester mixture or thin faction down into second digested material. In addition to processing a portion of the waste slurry, the secondary digester 82 may further be configured to release useable energy from the second digester mixture. In the example first waste processing system 20, the second digested material is allowed to flow into the example storage facility 56. A portion of the liquids collected by the reception pit 32 may be fed back into the dairy flush facility 30 as depicted in FIG. 1.

In a waste processing system constructed in accordance with the principles of the present invention, the ratio of the percentage of solids in the first digester mixture to the percentage of solids in the second digester mixture is within a first range of approximately 5:1 to 10:1 and in any event should be within a second range of approximately 2:1 to 15:1. In the first example waste processing system 20, the ratio of the percentage of solids in the first digester mixture to the percentage of solids in the second digester mixture is approximately between 7:1 and 8:1.

The primary digester 80 may be characterized as a low-rate digester, while the secondary digester 82 may be characterized as a high-rate digester. In particular, in a waste processing system constructed in accordance with the principles of the present invention, the primary digester 80 should completely process the first digester mixture in a first range of approximately 10 to 100 days and in any event should be within a second range of approximately 15 to 40 days. In the first example waste processing system 20, the primary digester 80 processes the first digester mixture in approximately 20 days. On the other hand, the secondary digester 82 should completely process the second digester mixture in a first range of approximately 6 hours to 8 days and in any event should fully process the second digester mixture within a second range of approximately 12 hours to 5 days. In the first example waste processing system 20, the second digester 82 processes the second digester mixture in approximately 1 day.

The ratio of the digestion rates of the first and second digesters of a waste processing system of the present invention should be within a first range of approximately 1.5:1 to 5:1 and in any event be within a second range of approximately 1.5:1 to 3:1. The ratio of the digestion rates of the example primary digester 80 and the example secondary digester 82 is approximately 2:1.

The first digester mixture fed into the primary digester 80 should have a solid content of within a first range of approximately 6% to 10% and, in any event, the solid content of the first digester mixture should be within a second range of approximately 4% to 20%. In the first example waste processing system 20, the first digester mixture has a solid content of approximately 7% to 8%. The second digester mixture should have a solid content of within a first range of approximately 0.5% to 2% and, in any event, the solid content of the second digester mixture should be within a second range of approximately 0.25% and 4%. In the first example waste processing system 20, the second digester mixture has a solid content of approximately 1%.

The use of two separate digesters having different characteristics optimizes the overall digestion rate of the first example waste processing system 20. The first example waste processing system 20 thus yields improved rates at which the waste slurry is processed into flush liquid appropriate for use by the flush system and dry solids appropriate for storage and/or disposal.

### II. Second Example

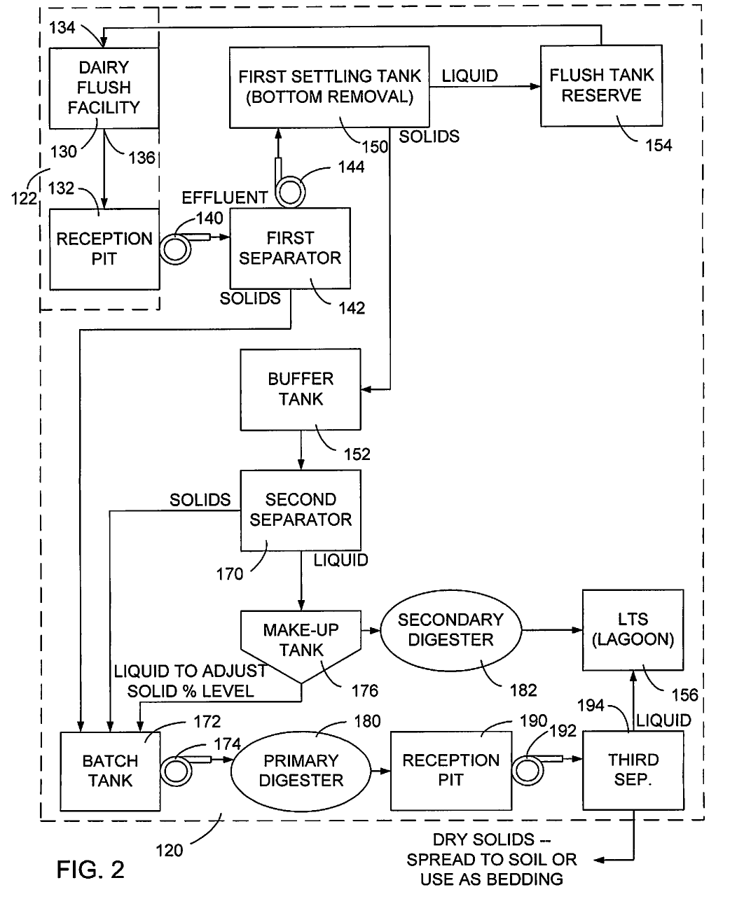

Referring now to FIG. 2 of the drawing, depicted therein is a second example waste processing system 120 adapted to be used with a flush system 122. The example flush system 122 is or may be conventional and comprises a dairy flush facility 130 and a reception pit 132. The flush facility 130 comprises an inlet 134 through which flush fluid is introduced and an outlet 136 through which waste slurry is collected. During use of the flush system 122, the flush liquid is mixed with the animal waste to form waste slurry. The waste slurry flows through the outlet 136 and is collected in the reception pit 132.

The second example waste processing system 120 comprises a reception pit pump 140, a first separator 142, a first separator pump 144, a first settling tank 150, a buffer tank 152, a flush reserve tank 154, a long term storage facility 156 such as a lagoon, a second separator 170, a batch tank 172, a batch tank pump 174, a make-up tank 176, a primary digester 180, a secondary digester 182, a reception pit 190, a reception pit pump 192, and a third separator 194.

The second example waste processing system 120 operates basically as follows. The reception pit pump 140 pumps waste slurry from the reception pit 132 into the first separator 142. The first separator 142 causes a first portion of the waste slurry (first thick fraction) to flow into the batch tank 172, and the first separator pump 144 pumps a second (effluent) portion of the waste slurry (first thin fraction) into the first settling tank 150.

The first settling tank 150 causes a third portion of the waste slurry (second thick fraction) to flow into the buffer tank 152 and a fourth portion of the waste slurry (second thin fraction) to flow into the flush reserve tank 154. If used, the second buffer tank 152 causes a fifth portion of the waste slurry (second thick fraction) to flow into second separator 170.

The second separator 170 causes a sixth portion of the waste slurry (third thick fraction) to flow into the batch tank 172 and a seventh portion of the waste slurry (third thin fraction) to flow into the make-up tank 176. The make-up tank 176 uses part the seventh portion of the waste slurry to form a digester pre-mixture (fourth thick fraction) and allows the digester pre-mixture to flow into the batch tank 172 to mix with the contents of the batch tank 172 (i.e., first and sixth portions of the waste slurry) to form a first digester mixture. The batch tank pump 174 forces the first digester mixture into the primary digester 180.

The primary digester 180 breaks the biodegradable material in the first digester mixture down into first digested material. The first digested material is allowed to flow into the reception pit 190. In addition to processing a portion of the waste slurry, the primary digester 180 may further be configured to release useable energy from the first digester mixture.

The make-up tank 176 further uses part of the seventh portion of the waste slurry to form a second digester mixture (fourth thin fraction) and allows the second digester mixture to flow into the secondary digester 182. The secondary digester 182 breaks the biodegradable material in the second digester mixture down into second digested material. In addition to processing a portion of the waste slurry, the secondary digester 182 may further be configured to release useable energy from the second digester mixture. The second digested material is allowed to flow into long term storage 156 such as a storage lagoon.

The first digested material within the reception pit 190 forms a final digested material. The reception pit pump 192 forces the final digested material into the third separator 194. The third separator 194 allows a liquid portion of the final digested material to flow into one or both of the settling pond 156 and the flush reserve tank 154. The third separator 194 further yields dry solids that may be disposed of (e.g., spread directly on soil or used as bedding material).

The liquids stored in the flush reserve tank 154 are appropriate for use as the flush liquid used by the flush system 122. Accordingly, the inlet 134 of the flush facility 130 is operatively connected to the flush reserve tank 154.

The primary digester 180 and the secondary digester 182 are configured to process digester mixtures having different characteristics.

In a waste processing system constructed in accordance with the principles of the present invention, the ratio of the percentage of solids in the first digester mixture to the percentage of solids in the second digester mixture is within a first range of approximately 5:1 to 10:1 and in any event should be within a second range of approximately 2:1 to 15:1. In the second example waste processing system 120, the ratio of the percentage of solids in the first digester mixture to the percentage of solids in the second digester mixture is approximately between 7:1 and 8:1.

The primary digester 180 may be characterized as a low-rate digester, while the secondary digester 182 may be characterized as a high-rate digester. In particular, in a waste processing system constructed in accordance with the principles of the present invention, the primary digester 180 should completely process the first digester mixture in a first range of approximately 10 to 100 days and in any event should be within a second range of approximately 15 to 40 days. In the second example waste processing system 120, the primary digester 180 completely processes the first digester mixture in approximately 20 days. On the other hand, the secondary digester 182 should completely process the second digester mixture in a first range of approximately 6 hours to 8 days and in any event should fully process the second digester mixture within a second range of approximately 12 hours to 5 days. In the second example waste processing system 120, the second digester 182 completely processes the second digester mixture in approximately 1 day.

The ratio of the digestion rates of the first and second digesters of a waste processing system of the present invention should be within a first range of approximately 1.5:1 to 5:1 and in any event be within a second range of approximately 1.5:1 to 3:1. The ratio of the digestion rates of the example primary digester 180 and the example secondary digester 182 is approximately 2:1.

A make-up tank of a waste processing system of the present invention should generate the digester pre-mixture such that the first digester mixture has a solid content of within a first range of approximately 6% to 10% and, in any event, the solid content of the first digester mixture should be within a second range of approximately 4% to 20%. In the second example waste processing system 120, the example make-up tank 176 creates a digester pre-mixture such that the first digester mixture has a solid content of approximately 7% to 8%. On the other hand, the make-up tank of a waste processing system of the present invention should generate a second digester mixture having a solid content of within a first range of approximately 0.5% to 2% and, in any event, the solid content of the second digester mixture should be within a second range of approximately 0.25% and 4%. In the second example waste processing system 120, the example make-up tank 176 creates a second digester mixture having a solid content of approximately 1%.

The use of two separate digesters having different characteristics optimizes the overall digestion rate of the second example waste processing system 120. The second example waste processing system 120 thus yields improved rates at which the waste slurry is processed into flush liquid appropriate for use by the flush system and dry solids appropriate for disposal by spreading directly on the soil.

### III. Third example

In the second example waste processing system 120 described above, gravity will cause the solids within the waste slurry or material within the first settling tank 150 to settle towards the bottom of the first settling tank 150, and removal of the solids portion is performed by allowing material to flow from the bottom of the tank (i.e., bottom removal). Removal of the liquid portion is performed by skimming or otherwise removing liquids off of the top of the tank.

One problem with such settling tank type separators is that the waste slurry collected by the first settling tank 150 will tend to stratify over time if the removal of the solids and liquid portions of the waste slurry is not properly managed. In particular, if the rate at which the waste slurry is removed from the bottom of the first separator (i.e., solids portion) is too low, a layer or zone of heavy and/or emulsified solids may collect towards the bottom of the first settling tank 150. However, if the rate at which the waste slurry is removed from the bottom of the first separator (i.e., solids portion) is too high, the level of liquids in the material removed from the bottom of the first settling tank 150 may be too high for proper functioning of the primary (low rate) digester 180.

A mechanical rake or other means of collecting the solids within the first settling tank 150 may be used but requires significant capital investment and operational and maintenance costs. More typically, then, the second separator 170 and/or make-up tank 176 are used instead of a mechanical stirring system to allow the solids portion of the material in the first settling tank 150 to be removed at a sufficiently high rate to prevent build-up of solids within the first settling tank 150. The optional second separator 170 and/or optional make-up tank 176 remove liquids from the solids portion removed from the first settling tank for processing by the secondary (high rate) digester 182 yet maintain the level of the removed solids within the range necessary for satisfactory functioning of the primary (low rate) digester 180.

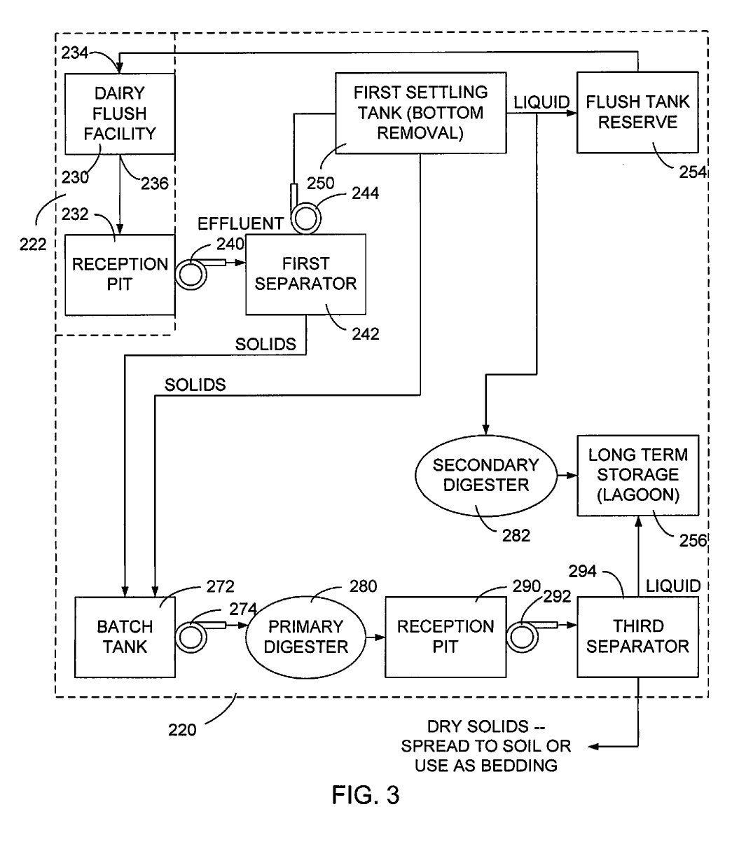

An alternative to the second example waste processing system 120 is depicted in FIG. 3 of the drawing. In particular, FIG. 3 depicts a third example waste processing system 220 incorporating the principles of the present invention. The third example waste processing system 220 operates in the same basic manner as the second example waste processing system 120 but does not use a second separator or make-up tank upstream of the secondary digester.

In particular, the third example waste processing system 220 is also adapted to be used with a flush system 222. Again, the example flush system 222 is or may be conventional and comprises a dairy flush facility 230 and a reception pit 232. The flush facility 230 comprises an inlet 234 through which flush fluid is introduced and an outlet 236 through which waste slurry is collected. During use of the flush system 222, the flush liquid is mixed with the animal waste to form waste slurry. The waste slurry flows through the outlet 236 and is collected in the reception pit 232.

The third example waste processing system 220 comprises a reception pit pump 240, a first separator 242, a first separator pump 244, a first settling tank 250, a flush reserve tank 254, a long term storage facility 256 such as a lagoon, a batch tank 272, a batch tank pump 274, a primary digester 280, a secondary digester 282, an optional reception pit 290, a reception pit pump 292, and a third separator 294.

In the third example waste processing system 220, careful management of the removal of the first portion of the waste slurry from the first settling tank 250 is used as an alternative to the subsequent removal of excess liquids using the separator systems such as the second separator 170 and/or make-up tank 176. In particular, if first settling tank is managed with sufficient care, the first portion of the waste slurry may be removed from the first settling tank 250 such that build up of solids within this first settling tank 250 is prevented and such that the level of liquids within the removed solids portion does not exceed the level that might inhibit proper functioning of primary digester 280. In this case, the removal of the first portion of the waste slurry from the first settling tank 250 may be controlled manually or may be performed automatically by a combination of sensors, controllers, and valves. In this case, a portion of the thin portion from the first settling tank 250 would go to the secondary digester 282.

### IV. Fourth Example

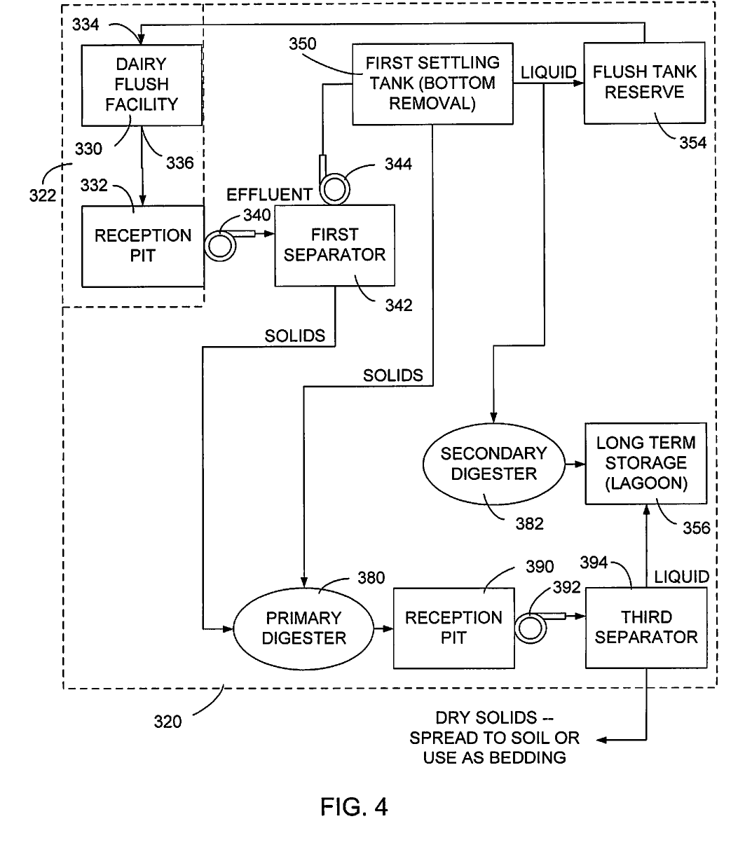

Additionally, a waste processing system of the present invention may be implemented entirely as a continuous rather than a patch processing system. In particular, depicted in FIG. 4 of the drawing is a fourth example waste processing system 320 constructed in accordance with the principles of the present invention. The fourth example waste processing system 320 operates in the same basic manner as the third example waste processing system 220 but does not use a batch tank upstream of the primary digester.

The fourth example waste processing system 320 is adapted to be used with a flush system 322. Again, the example flush system 322 is or may be conventional and comprises a dairy flush facility 330 and a reception pit 332. The flush facility 330 comprises an inlet 334 through which flush fluid is introduced and an outlet 336 through which waste slurry is collected. During use of the flush system 322, the flush liquid is mixed with the animal waste to form waste slurry. The waste slurry flows through the outlet 336 and is collected in the reception pit 332.

The fourth example waste processing system 320 comprises a reception pit pump 340, a first separator 342, a first separator pump 344, a first settling tank 350, a flush reserve tank 354, a long term storage facility 356 such as a lagoon, a primary digester 380, a secondary digester 382, an optional reception pit 390, a reception pit pump 392, and a third separator 394. In the example depicted in FIG. 4, the solids output of the first separator 342 flows or is pumped directly into the primary digester 380, while the solids output of the first settling tank 350 flows or is pumped directly into the secondary digester 382. Careful management of the removal of the solids portion of the material in the first separator 342 and in the first settling tank 350 allows the fourth example waste processing system 320 to operate in a continuous manner. Again, the removal of the solids portions of the materials in first separator 342 and in the first settling tank 350 may be controlled manually or may be performed automatically by a combination of sensors, controllers, and valves.

### V. Fifth example

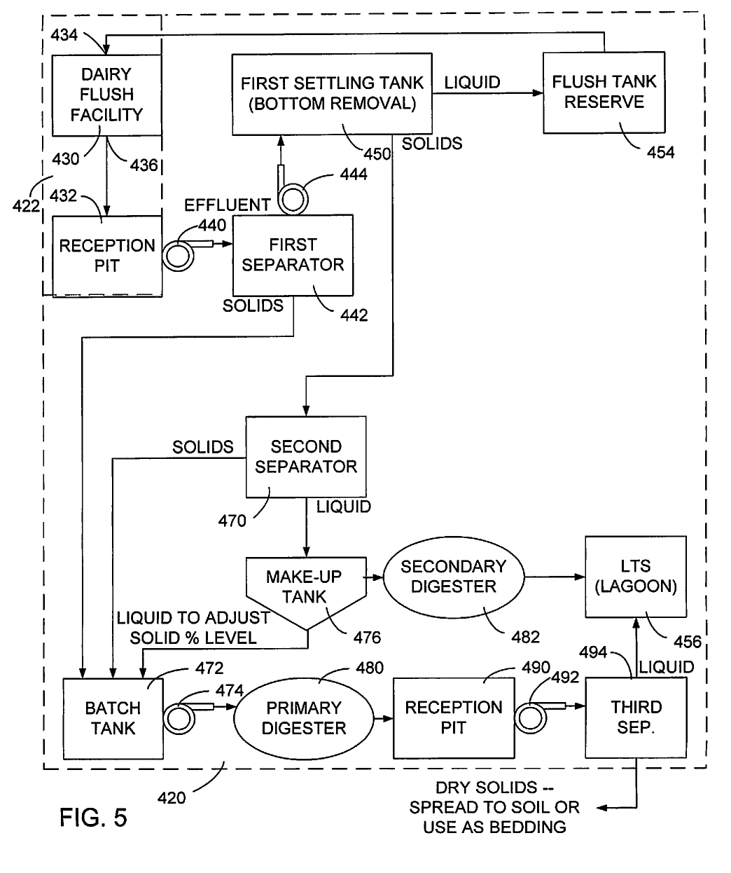

Another alternative to the second example waste processing system 120 is depicted in FIG. 5 of the drawing. In particular, FIG. 5 depicts a fifth example waste processing system 420 incorporating the principles of the present invention. The fifth example waste processing system 420 operates in the same basic manner as the second example waste processing system 120 but does not use a buffer tank upstream of the secondary digester.

In particular, the fifth example waste processing system 420 is also adapted to be used with a flush system 422. Again, the example flush system 422 is or may be conventional and comprises a dairy flush facility 430 and a reception pit 432.

The flush facility 430 comprises an inlet 434 through which flush fluid is introduced and an outlet 436 through which waste slurry is collected. During use of the flush system 422, the flush liquid is mixed with the animal waste to form waste slurry. The waste slurry flows through the outlet 436 and is collected in the reception pit 432.

The fifth example waste processing system 420 comprises a reception pit pump 440, a first separator 442, a first separator pump 444, a first settling tank 450, a flush reserve tank 454, a long term storage facility 456 such as a lagoon, a second separator 470, a batch tank 472, a batch tank pump 474, a make-up tank 476, a primary digester 480, a secondary digester 482, an optional reception pit 490, a reception pit pump 492, and a third separator 494.

The fifth example waste processing system 420 operates in the same basic manner as the second example waste processing system 120 described above, but no buffer tank is arranged between the first settling tank 450 and the second separator 470.

What is claimed is:

1. A flush system for processing waste slurry containing animal waste, comprising:
a primary separator for separating the waste slurry into a first portion and a second portion;
a primary digester for digesting the first portion; and
a secondary digester for digesting at least part of the second portion;
wherein
a solids content of the first portion is higher than a solids content of the second portion.

2. A flush system as recited in claim 1, further comprising a vessel for adjusting a percentage of solids in the first portion entering the primary digester.

3. A flush system as recited in claim 1, further comprising a second separator arranged between the primary separator and the secondary digester.

4. A flush system as recited in claim 1, in which at least one of the primary digester and the secondary digester operate on a continuous basis.

5. A flush system as recited in claim 1, in which the primary digester and the secondary digester operate on a continuous basis.

6. A flush system as recited in claim 1, in which at least one of the primary digester and the secondary digester operate on a batch basis.

7. A flush system as recited in claim 1, in which the primary digester and the secondary digester operate on a batch basis.

8. A flush system as recited in claim 1, further comprising a vessel for removing solids from the second portion entering the secondary digester.

9. A flush system as recited in claim 1, further comprising a vessel for removing liquids from the second portion entering the secondary digester, where the liquids removed from the second portion are used to adjust a percentage of solids in the first portion entering the primary digester.

10. A flush system as recited in claim 8, in which the vessel is a separator.

11. A flush system as recited in claim 8, in which the vessel is a make-up tank.

12. A flush system as recited in claim 8, further comprising:
a first separator for removing separating the waste slurry into the first portion and the second portion;
a second separator for removing liquids from the second portion; and
a make-up tank for removing liquids from the second portion; whereby at least a portion of the liquids removed from the second portion are used to adjust a percentage of solids in the first portion entering the primary digester.

13. A method of processing waste slurry containing animal waste, comprising:
separating the waste slurry into a first portion and a second portion, where a solids content of the first portion is higher than a solids content of the second portion;
digesting the first portion in a primary digester; and
digesting the second portion in a secondary digester.

14. A method as recited in claim 13, further comprising the step of adjusting a percentage of solids in the first portion.

15. A method as recited in claim 13, further comprising the step of removing liquids from the second portion.

16. A method as recited in claim 13, further comprising the steps of:
removing liquids from the second portion; and
adjusting a percentage of solids in the first portion using the liquids removed from the second portion.

17. A flush system for processing waste slurry containing animal waste, comprising:
a first vessel for separating the waste slurry into a first thick fraction and a first thin fraction;
a second vessel for separating the first thin fraction of the waste slurry into a second thick fraction and a second thin fraction;
a low-rate digester for digesting the first thick fraction and at least a portion of the second thick fraction; and
a high-rate digester for digesting at least a portion of the first thin fraction.

18. A flush system as recited in claim 17, further comprising a vessel for adjusting a percentage of solids of the combination of the first and second thick fractions.

19. A flush system as recited in claim 17, further comprising a third vessel for separating the second thick fraction into a third thick fraction and a third thin fraction, where:
the low-rate digester digests the third thick fraction; and
the high-rate digester digests at least a portion of the third thin fraction.

20. A flush system as recited in claim 19, further comprising a fourth vessel for separating the third thin fraction into a fourth thick fraction and a fourth thin fraction, where:
the low-rate digester digests the fourth thick fraction; and
the fourth thin fraction is used to adjust a fluid level of the combination of the first, second, and third thick fractions.
